(19) United States
(12) Patent Application Publication
(10) Pub. No.: US 2009/0128486 A1
(43) Pub. Date: May 21, 2009

(54) Method of Drawing a Graphical Object

(75) Inventors: Rutger Nijlunsing, Eindhoven (NL); Raymond Joseph Elisabeth Habets, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,353

(22) PCT Filed: Sep. 11, 2006
(86) PCT No.: PCT/IB2006/053196

§ 371 Date: Mar. 19, 2008

(30) Foreign Application Priority Data
Sep. 19, 2005 (EP) 05108606.4

(51) Int. Cl. G09G 5/08

(52) U.S. Cl. 345/157

(57) ABSTRACT

A method is presented to control the value of an attribute of a graphical object in an image displayed on a visual display screen, comprising use of a position indicator represented on the visual display screen and comprising use of a user interaction tool to generate user events and control the position of the position indicator represented on the visual display screen. The method makes the control of the attributes of graphical objects more efficient by mapping the value of the attribute to time in that the value of the attribute is controlled by the length of time between the pair of user events. The invention also relates to a computer program, a web service for the viewing and/or processing of medical images, an imaging system, a workstation and a Picture Archiving and Communication System (PACS).

The invention relates to a method to control the value of an attribute of a graphical object in an image displayed on a visual display screen, the method comprising use of a position indicator represented on the visual display screen, and further comprising use of a user interaction tool to generate user events and control the position of the position indicator represented on the visual display screen, whereby the user interaction tool is used to position the position indicator at a position in the visual display screen related to the graphical object, and in which a pair of user events are initiated by the user via the user interaction tool.

It is generally known to create computerized graphical objects, for instance lines, circles or other more complicated constructions, by positioning a cursor at a point in the image displayed on a visual display screen, placing there an exemplary version of the required object and then by the use of handles dragging one or other attribute of the object, such as length or radius for example, across the image until the object is of the required size. This requires a mix of user interaction tool techniques because it requires of the user the ability to place a cursor using a user interaction tool, initiate some user interaction with the interaction tool, such as the depression of a button, and at the same time the ability to drag a handle on the visual display screen.

U.S. Pat. No. 4,622,641 describes a system in which the production and size of a graphical object, for example a circle, is controlled using a user interaction tool, in this case a joystick, which is used to position a position indicator, in this case a cursor, on an image displayed on a visual display screen. The joystick is used to generate user events, in this case by pressing the joystick button, and each such user event increases the radius of the circle by one pixel. When the circle is of an appropriate size the user presses the F10 button to terminate the circle expansion command. This method also requires a complex interaction between various user interaction tool techniques to control the computer graphic because it requires a mixture of initial cursor placement and then repeated cursor manipulation via the joystick.

It is an object of the invention to control the creation or editing of a graphical object with more efficient control.

This is achieved according to the method of the invention whereby the value of the attribute is controlled by the length of time between the pair of user events.

A graphical object can be any object displayed in an image on a visual display screen, a non-exclusive list of examples of which would include a region of interest, a circle, a line, a rectangle, a fixed angle between two lines, a segmentation mesh, or a contour. Other examples are possible and are known to those skilled in the art.

There are various types of attributes.

One type of attribute of a graphical object can be any parameter which when visually displayed allows the viewer to recognize the graphical object for what it is or to differentiate it from other such graphical objects of a similar type. In other words it can be thought of as a structural attribute, albeit in image space. Such parameters include for example radius, length, color, mesh patch size and orientation, as is known in the art. The graphical objects are displayed with a required size and orientation by allowing the attributes to take a specific value. For example, the radius of a graphical object which is a circle may take a value of 3 cm, or, a graphical object which is a rectangle may be defined by two attributes, both lengths, with values of say 4 cm and 5 cm, used as the lengths of the sides of the rectangle. The system processor applies the values to the attributes of the graphical object and displays the result, and depending on the graphical object and the inherent attributes used to describe it, each exact value can be reproduced on the screen, or can be scaled before display using a calibration factor, as is known in the art.

Another type of attribute is some parameter assigned to the graphical object by the user. An example of an attribute that is assigned is user certainty of identification, in which a user may wish to indicate with reference to an automatically generated graphical object by how much he or she is certain that it has been correctly generated. Closely related to this is user identified spacial certainty, in other words by how much the user is certain that the object is positioned at the correct coordinates in the image. Another example is user identified importance, in which the user uses the invention to assign information to a graphical object about how important that particular graphical object is, using some user understood criteria. Similarly the user can assign a ranking of importance to a graphical object, indicating the importance it has within the image in relation to a set of further objects within the image. Such assigned parameters, when assigned by the user, may be thought of as subjective parameters.

The invention may be used with any user interaction tool that can be programmed to produce user events. A user event is any signal sent by the user to the system processor by activation of the user interaction tool. A user interaction tool can be any tool set up to provide a channel of communication from the user to the system processor and therefore includes computer mouse, joystick, computer pen and keyboard, amongst others. The invention is particularly usefully applied to any manually or pedally operated user interaction tools.

For the display of a graphical object on a visual display screen to be successfully accomplished the values of any structural attributes of the graphical object must be communicated to the system processor controlling the display. The system processor uses the attributes to construct a graphical object on the visual display screen which has the required, or stipulated, attribute values. The attributes, and their values, in essence define the display of the graphical object. So by controlling and stipulating the values of the attributes the user is controlling how the graphical object will look on the visual display screen. Any assigned subjective parameter may also be displayed visually at an appropriate time.

Instead of using a succession of user events or a sequence of different user events to control the values of attributes, as in U.S. Pat. No. 4,622,641, the invention uses a time interval, the time difference between user events on a user interaction device to control the values of attributes. The value of the attribute increases as the time interval between a pair of user events is allowed to increase by the user. In other words, the value of the attribute is controlled not by the number of user events produced by the user interaction tool, or by the distance over which a handle, say, is dragged, but by a length of time. This length of time can be controlled by the user interaction tool and quantified by the system processor. The invention can be looked at another way in that it can be seen as the mapping of the values of the attributes to time. The resultant values, when they are the values of so called structural attributes, are used by the system processor to construct the graphical object. The resultant subjectively assigned attributes can be used by the system as is useful to the computer package or data processing activity taking place.

The technical feature of using the time interval between user events to control the values of attributes allows the user to control how the graphical object looks in a more efficient way and allows the user to control information about the graphical object. The mapping of the time interval between user events to the value of the attribute produces a required value while requiring a simpler user interaction. This thereby allows a simplification of the drawing, controlling and/or handling procedure and reduces overall user interaction. The feature of mapping the time interval between user events to the value of the attribute allows one less form or type of user interaction. This feature allows more efficient control of the attributes of the graphical object and therefore solves the problem of how to control the creation and editing of a graphical object in a more efficient way.

In applying the invention, the generation of user events is determined by the type of user interaction tool used. For example, in applying the invention to the drawing of graphical objects using a computer mouse, options for providing user events which can be communicated to the system processor include: an executed mouse click using a mouse button; the beginning, or engagement, of a mouse click, in which a mouse button is depressed but not yet released, otherwise known to the skilled person as mouse-down; the bringing into contact of a mouse with a contact sensitive mouse pad; the end of a mouse click, in which the mouse button already depressed is released, known to the skilled person as mouse-up; the removal of a mouse from a contact sensitive mouse pad. These are all operations that, as is known by persons skilled in the art, generate user events interpretable by the system processor.

If the user interaction tool is a joystick, the main interaction capable of generating user events is the joystick manipulation. If, however, the joystick includes a button then the same user interactions capable of being produced by the mouse buttons can be generated by the joystick button.

Similarly, if the user interaction tool is a computer pen in association with a pen pad, often known in the art as a tablet, interactions capable of generating user events include: pen down on the pen pad; pen tap on the pen pad; and pen up from the pen pad.

If the user interaction tool is a keyboard, interactions capable of generating user events include key depression, in which a key is depressed and held; key tap, in which a key is depressed and then released, as in normal typing; and key release, in which a key already held down is released.

The application of the invention to the drawing of computerized graphical objects within an image on a visual display screen can be readily performed by anyone skilled in the art of the system used to display the images and the exact code used to apply the invention will depend on the computer package and operating system used and is therefore beyond the scope of this text.

An embodiment of drawing a circle of a desired diameter and placed at a desired location within a computer image allows a particularly exemplary explanation of the invention. This example shows how a circle can be drawn by mapping the radius of the circle to time. An embodiment by which the circle can be drawn is as follows. In this embodiment a computer mouse, as an example of a commonly used and also versatile user interaction tool is used as the user interaction tool. The user manipulates the mouse to control the position indicator, or cursor, to indicate on the image where the center of the circle is required. The user then initiates a user event, for example a button depression, or click, and the system begins to calculate an increasing value for the radius of the circle. When the user initiates a second user event, for example a further button depression, the value for the radius of the circle stops increasing and is set as the value of the radius. The created circle, with the correct radius value, is then displayed on the screen, centered around the point indicated by the cursor. A simple alternative to providing two button clicks is to have the user depress the mouse button to initiate the start of radius growing and release the button to end radius growing.

In this particular embodiment the position indicator was positioned at the center of the intended circle, but this is not actually necessary. The position indicator may be placed anywhere in the image on the visual display screen which is recognized by the system processor as being related to the graphical object to be produced. For example, as an alternative, the position indicator may be position on a side pane to the image labeled “circle”. Upon generation of a first user event the value of the radius of the circle starts to increase and upon generation of the second user event the value of the radius stops increasing. The circle may be placed anywhere in the image by the user once it is fully generated and displayed.

The radius may, but need not, be graphically depicted in the image while it is increasing. In other words, the radius and/or the circle may be depicted as growing in real time in the temporal interval between the two user events. Although it is advantageous for the user if this is shown in the image because it provides clear and contextual visual feedback to the user of the size of the circle at any instant, it is not actually necessary. The value of the radius of the circle at any instant can be communicated to the user in other ways. For example, the value can be shown numerically in a side pane on the visual display screen. This would be particularly advantageous if the user, aware of the magnification factor of the image and therefore the relative sizes of individual items within the image, knew in advance that a circle of a particular size was required.

The invention can be used not only to draw a circle in a desired location in the image, but also to further control or edit the attributes of an existing circle. In this case, the time between user events is used to further modify the attribute being controlled. In the case of a circle, the first user interaction via the mouse, say, would initiate an increase or decrease in radius, and the second user interaction would stop further change in this value.

How the value of the radius, in other words the value of the attribute, is increased by the system processor is a matter of design for the skilled person. In the embodiment of circle creation, for example, an initial value of zero may be set to the attribute of radius, this value increasing in incremental steps as the time interval between user events increases. The magnitude of the incremental steps is a matter of design for the person skilled in the imaging package. In the embodiment of circle editing, the initial value of the radius attribute would be the value already assigned to the radius.

How the invention is accessed by the user in the context of any particular program utilizing it is a matter of design for the skilled person. For example, the program may offer a button for the user to click thereby initiated circle placement and growing. The circle can then subsequently be centered at the position of the cursor indicated by the user via the mouse. The subsequent pair of user events start and then stop radius growth and allow the placing of the grown circle in the image.

As an example of how this offers a further embodiment of the invention to the user, the user may initiate the circle growing program by clicking a button, and then by using a mouse or computer pen, both in combination with a mouse or pen pad configured to recognize the placement of the mouse or pen, simply bring the mouse or pen down as the first user event which initiates the start of radius value growth. The user initiates the second user event by lifting the mouse or pen off the pad. The grown circle is shown on the image centered at the position of the cursor in the screen. This is particularly useful, for example, if the user wants to position the cursor at the correct point in the image before initiating the program, or if the user wants to create a circle of the correct size first before manipulating it to the correct position in the image.

As an example of how the invention may be applied to the increasing or decreasing of circle radius, the program in which the invention is applied may be arranged so that if the user selects an existing circle to edit and initiates user events at a position outside the circumference of the circle, the radius of the circle increases, while if the user initiates user events inside the circumference, the radius of the circle decreases.

The embodiment of the circle may, by extension, be applied to the drawing of a graphical sphere within the image.

The invention also relates to a computer program to control the value of an attribute of a graphical object in an image displayed on a visual display screen, the computer program comprising code to receive first data from a user interaction tool, which first data is used to control the position of a position indicator on the visual display screen, and also receive second data from the user interaction tool, which second data is representative of a pair of events generated with the user interaction tool.

In this the computer program is characterized in that the value of the attribute is controlled by the length of time between the pair of events. Such a program is designed to carry out the method of the invention.

The invention is particularly applicable to orthopaedic analysis software. Use of such software may require the user to create a complex sequence of graphical objects.

Therefore the invention also relates to a program for the viewing of medical images, a web service for the viewing and/or processing of medical images, an imaging system, for the acquisition and viewing of medical image, a workstation for the viewing and processing of medical images and a Picture Archiving and Communication System (PACS).

These and other aspects of the invention are explained further with reference to the accompanying drawings.

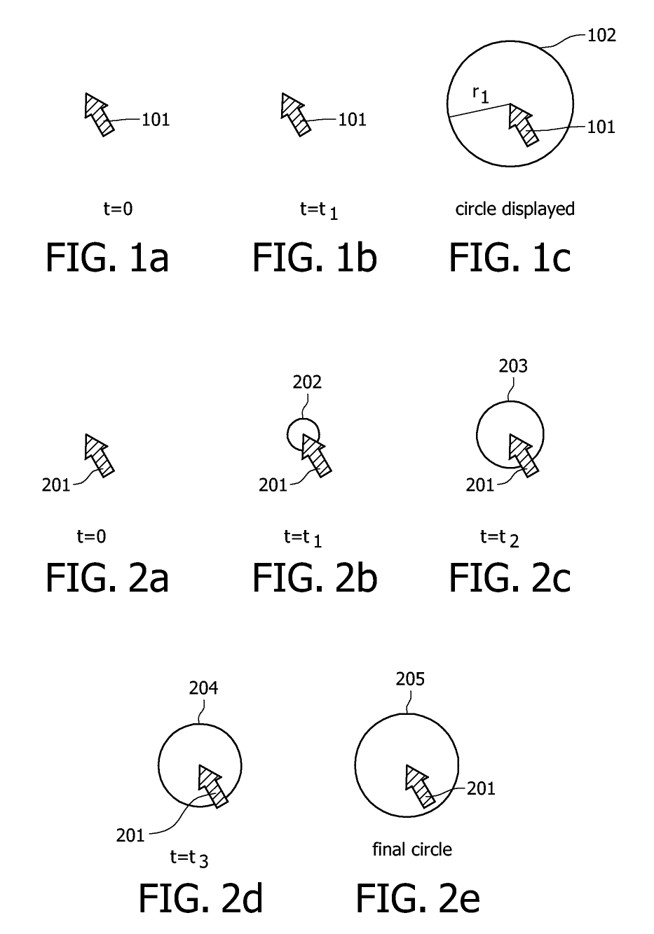

FIGS. 1a-c show the invention as applied to the embodiment of the circle, in which the circle is not displayed until the end of the use of the method.

FIGS. 2a-e show the inventions as applied to the embodiment of the circle, in which the circle is displayed during the use of the method.

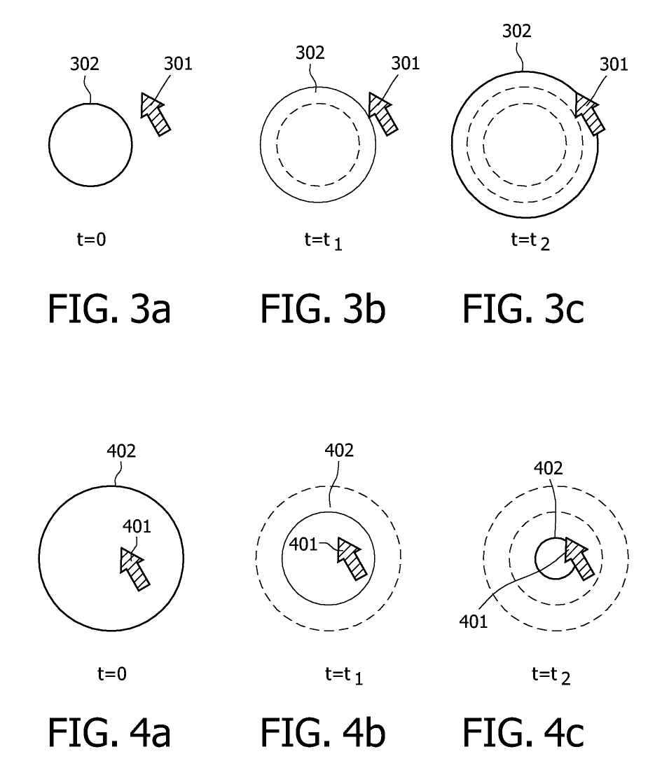

FIGS. 3a-c show the invention as applied to the embodiment of circle editing.

FIGS. 4a-c also show the invention as applied to the embodiment of circle editing.

FIG. 1 shows the invention as applied to the embodiment of the circle, in which the circle is not displayed until the end of the use of the method. A cursor 101 is visible on the display screen and at a time t=0 the user initiates a user event and then initiates a second user event at a time t=t₁ later. The time difference ti between the two user events is used to calculate the radius r₁ of the circle, where r₁={f(t₁)}, in other words, r₁ is a function of t₁ and the circle with the correct radius is displayed.

FIG. 2 shows the inventions as applied to the embodiment of the circle, in which the circle is displayed during the use of the method. Here, the cursor 201 is visible on the display screen and at a time t=1 the user initiates a user event and then initiates a user event at a time t₄ later. At the first user event a circle starts to grow around the point of the cursor, the radius of which circle increases with time. Radius growth ceases at time t₄, and at times t₁, t₂ and t₃ in-between the circle is displayed as it grows. The display of the circle may be continuous or may be displayed on the visual display screen only when the radius of the circle achieves certain values.

FIG. 3 shows the invention as applied to the embodiment of circle editing in which the radius of the circle is increased. The cursor 301 is used by the user to indicate a position outside the existing circumference of the circle 302. The user initiates a user event and the radius starts to grow. The increasing circle is shown in the figure as displayed during the time interval between user events but this is not necessary. At time t₂ later the user initiates another user event and the circle stops expanding.

FIG. 4 shows the invention as applied to the embodiment of circle editing in which the radius of the circle is decreased. The cursor 401 is used by the user to indicate a position inside the existing circumference of the circle 402. The user initiates a user event and the radius starts to shrink. The decreasing circle is shown in the Figure as displayed during the time interval between user events but this is not necessary. At time t₂ later the user initiates another user event and the circle stops decreasing.

The positioning of the cursor outside or inside of the circumference of the existing circle to indicate growth or shrinkage is just one way in which the skilled person, when employing the invention, may use to signal to the system processor that editing and graphical object growth, or editing and graphical object shrinkage is to be undertaken. As is known by the skilled person, there are various ways in which options in a graphical package can be accessed by the user and this is a matter of design and is not the subject matter of this invention.

Further applications of the invention are now described.

The invention may also be applied to the drawing of an ellipse. As is known, an ellipse has two axes, a major axis and a minor axis. At initiation of the first user event, one of the axes starts to increase in length from zero until a second user event occurs, at which point the first axis does not undergo any further increase in length and the other axis begins to increase in length from zero. At a third user event, the second axis undergoes no further increase in length and the ellipse is complete.

As an example of how this may occur in practice, the first user event may be a mouse click at the position in the image where the user wishes to place the center of the ellipse, or a mouse-down if the cursor has already been placed at the required position. This first event initiates growth of the value of the length of the first axis. The second user event may be a mouse click. This stops the length of the first axis from increasing any further in value and starts the growth of the value of the length of the second axis. The third user event, which may be another mouse click or mouse-up, for example, stops any further increase in length in the second axis. The completed ellipse is visualized on the screen.

The invention can also be applied to the drawing of parallel or perpendicular lines. In this embodiment the length of a parallel line can be controlled by, for example, selecting a line already displayed on the visual display screen and then initiating a first user event which starts the growing of another line parallel to the line already selected. Upon the initiation of the second user event the growth of the second line stops. By extension, the method can also be applied to the drawing of a perpendicular line.

The invention can also be applied to the creation of a point on a line or on a contour. This may be achieved for example by the selection of a point on a line or contour, and then by initiating a first user event. The point selected is then visually identified, by the display of a dot, for example, and then moved along the line or contour until the user initiates a second user event, which causes the point to stop moving.

As an extension of the application of the invention to the drawing of a circle, the invention may also be applied to the drawing or controlling of a region of interest in the form of a contour. In many medical applications regions of interest are identified and displayed on images. Such contours can often be defined by a process of thresholding and region growing as is known in the art. The invention can be applied to the problem of contour display and can be applied to any known method of creating or editing a contour. This embodiment can also be applied to polyp and lung nodule identification on medical images. The user can use a variation of the circle growing or contour growing embodiments to signify polyp and nodules which are identifiable in the image.

The invention can also be used to assign a parameter to a graphical object. This is particularly advantageous in medical image assessment when assessing, for example, the probability of polyp and lung nodule identification. Given an image in which several polyps or lung nodules are already identified, the user can use the method of the invention to indicate how certain he or she is that the identification was correct. When the user initiates a first user event at the identified feature a value indicating, say, uncertainty of diagnosis starts to increase, and only stops increasing when the user initiates a second user event. In other words, the more uncertain about the diagnosis of the feature the user is, the longer he or she can allow between user events. The longer the time interval the higher the uncertainty, or conversely the lower the certainty, and these values can then be displayed for all identified features. This provides a simple yet intuitive way of allowing users to rank, or score, identified features. It can be used to allow comparison of physician diagnoses. It can be applied both to automatically detected and to previously manually detected polyps and lung nodules.

Similarly, the method of the invention may be used to allow the user to indicate how much he or she agrees with, for example, an automatic positioning of a graphical object. Following such automatic placement of an object the user may initiate a user event at the positioned object and initiate a second user event at some time later proportional to the amount by which he or she is certain or uncertain that the object is positioned correctly. This embodiment is applied more intuitively when the length of time between user events is proportional to the uncertainty. In this latter case, the results of applying this embodiment to a series of automatically generated graphical objects is that each one will have a score based on the degree by which the user believes the position to be inaccurate.

In a further embodiment, the invention may be used to assign a ranking to a series of graphical objects. In this case the user initiates a first user event and initiates a second user event at some instant later dependent on how important he or she considers the object to be. It can be seen that this embodiment is particularly useful because it allows the user to assign a ranking based on an assessment of each individual graphical object itself, without the user having to consider all objects at once and determine a ranking between them.

In the case in which the assigned attributes are subjective, it may be necessary to withhold display of the attribute until some later time. This is particularly useful in cases when the user does not need or does not require instant or immediate feedback, for example when the invention is used to assign ranking. The fact that the user cannot see any indication of the ranking as it is assigned allows the user to assess the importance of a feature while considering only the aspects of the feature itself, such as position, size and any anatomical features present.

As can be seen, the method of the invention allows the user an efficient way to control the attributes of a graphical object.

1. A method to control the value of an attribute of a graphical object in an image displayed on a visual display screen, the method comprising use of a position indicator represented on the visual display screen, and further comprising use of a user interaction tool to generate user events and control the position of the position indicator represented on the visual display screen, whereby the user interaction tool is used to position the position indicator at a position in the visual display screen related to the graphical object, and in which a pair of user events are initiated by the user via the user interaction tool, characterized in that, the value of the attribute is controlled by the length of time between the pair of user events.

2. A method as claimed in claim 1, characterized in that the value of the attribute is visually displayed as the attribute of the graphical object on the visual display screen as it is controlled.

3. A method as claimed in claim 1, characterized in that the second user event is initiated when the position indicator displayed on the visual display screen is at substantially the same position at which the first user event was initiated.

4. A method as claimed in claim 1, characterized in that the position in the visual display screen related to the graphical object, at which the position indicator is positioned, is a position which will be included in the graphical object when the control of the value of the attribute is terminated.

5. A computer program to control the value of an attribute of a graphical object in an image displayed on a visual display screen, the computer program comprising code to receive first data from a user interaction tool, which first data is used to control the position of a position indicator on the visual display screen, and also receive second data from the user interaction tool, which second data is representative of a pair of events generated with the user interaction tool, characterized in that, the value of the attribute is controlled by the length of time between the pair of events.

6. A computer program as claimed in claim 5, characterized in that the computer program further comprises code to display the value of the attribute on the visual display screen as the attribute of the graphical object as the value of the attribute is controlled.

7. A computer program product, comprising a computer program according to claim 5.

8. A program for the viewing of medical images, comprising a computer program according to claim 5.

9. A web service for the viewing and/or processing of medical images, comprising a computer program according to 5.

10. A web service as claimed in claim 9, characterized in that the computer program is arranged to be accessible on a server and arranged to be accessible by a remote computer.

11. An imaging system, for the acquisition and viewing of medical image, comprising a computer program according to claim 5.

12. A workstation for the viewing and processing of medical images comprising a computer program according to claim 5.

13. A Picture Archiving and Communication System (PACS) comprising a computer program according to claim 5.
